(19) United States
(12) Patent Application Publication
(10) Pub. No.: US 2006/0265464 A1
(43) Pub. Date: Nov. 23, 2006

(54) Method and system of certified electronic mail usung digital rights management

(76) Inventor: Nicholas N. Nassiri, El Segundo (CA)

Correspondence Address: NICK NASSIRI, SUITE 150, 11222 LA CIENEGA BLVD, INGLEWOOD, CA, 90304, US

(21) Appl. No.: 11/492,157

(22) Filed: Jul. 25, 2006

Related U.S. Application Data
(63) Continuation-in-part of application No. 09/982,145, filed on Oct. 17, 2001.
(60) Provisional application No. 60/241,235, filed on Oct. 17, 2000.

(51) Int. Cl. G06F 15/16

(52) U.S. Cl. 709/206

(57) ABSTRACT

A method, program and system to send an electronic message to an intended recipient wherein the originator of the electronic message elects to flag the outgoing electronic message with attributes that control various aspects of the electronic message processing and delivery using digital rights management (DRM). The digital rights management governs at least one of the following: message duration, printing authorization, end-user authorization, and verification, with respect to the outgoing electronic message. Further, the digital rights management provides the originator of the electronic message with an independent confirmation that verifies the time and date that the electronic message was sent and the time and date that it was delivered and the associated digital rights management attributes.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

1. Field of the Invention

The present invention relates generally to the field of electronic mail and more specifically it relates to a method, program, and system using digital rights management to control attributes of electronic message processing and electronic mail delivery and to provide the original originator of the electronic message with verification of the time and date that the electronic message was sent and the digital rights management associated with the electronic message.

1. Parent Case Text

This U.S. patent application claims the priority of U.S. application Ser. No. 09/982,145 filed on Oct. 17, 2001 entitled “Certified and Certified Electronic Mail System” which claims the priority of U.S. Provisional Patent Application No. 60/241235 filed on Oct. 17, 2000 entitled, “Certified and Certified Electronic Mail System” by the same inventor.

2. Description of the Prior Art

It can be appreciated that various methods of verifying the delivery of electronic mail have been in use. Typically, methods of electronic mail verification are comprised of electronic mail processing systems that track the path of the electronic message from originator to the intended recipient. Existing methods of delivery options typically comprise Message Disposition Notification (MDN) wherein the originator utilizes a “return receipt” as a controlling feature of the outgoing electronic message. A message flagged with a MDN allows the originator of the electronic message to know when an electronic message has been delivered to the intended recipient. An electronic flagged with MDN does not permit the originator to govern the processing or the delivery of an electronic message, beyond the confirmation that the electronic message was sent. The prior art discloses U.S. patent application Ser. No. 10/930653 entitled “Method of generating a certified electronic mail return receipt” filed by Su; Daisy Feng-Mei, et al; U.S. Pat. No. 6,807,277 entitled “Secure messaging system with return receipts” issued to Doonan, et al; U.S. Pat. No. 6,282,565 entitled “Method and apparatus for performing enterprise electronic mail management” issued to Shaw et al; U.S. Pat. No. 6,108,688 entitled “System for reminding a originator of an electronic mail if recipient of the electronic mail does not respond by a selected time set by the originator” issued to Nielson; U.S. Pat. No. 5,878,230 entitled “System for electronic mail messages wherein the originator designates whether the recipient replies or forwards to addresses also designated by the originator” issued to Weber, et al; and U.S. Pat. No. 5,694,616 entitled “Method and system for prioritization of electronic mail items by selectively associating priority attribute with at least one and fewer than all of the recipients” issued to Johnson, et al.

The Su; Diasy Feng-Mei application discloses a method of generating a certified electronic mail return receipt is provided. The method includes receiving an electronic mail requiring a certified electronic mail return receipt in a locked condition, prompting a person attempting to open the electronic mail to enter certified electronic mail return receipt information, collecting the certified electronic mail return receipt information entered by the person attempting to open the electronic mail, unlocking the electronic mail thereby enabling the electronic mail to be opened after the collecting step, opening the electronic mail after the collecting step for the person who entered the certified electronic mail return receipt information, and generating a certified electronic mail return receipt certifying that the electronic mail was received by the person who entered the certified electronic mail return receipt information.

The Doonan patent discloses a method and system for electronic messaging in which a originator of an electronic message receives a return receipt, without having to send the message contents to a third party. The originator contacts a server to obtain an encryption key to encrypt the message. The server returns an encryption key along with key retrieval information to the originator. The key retrieval information can be used to obtain from the server the decryption key corresponding to the returned encryption key. The originator encrypts the message using the encryption key and sends the message, along with the key retrieval information, to the recipient. The recipient sends the key retrieval information to the server to retrieve the corresponding decryption key. The recipient then decrypts the encrypted message received from the originator using the decryption key. When the recipient sends a request to obtain the decryption key, the server notifies the originator when the key has been successfully retrieved. The fact that the decryption key was retrieved by the recipient indicates to the originator that the recipient received the message.

The Shaw patent discloses an “enterprise” electronic mail system which is designed chiefly to process large volumes of electronic mail quickly and efficiently. The enterprise electronic mail system processes incoming electronic mail using a set of configurable rules that examine incoming messages for a specific attribute state condition and subsequently invoke a configurable action when the attribute satisfies the condition. The enterprise electronic mail system assigns a mail queue timer when a message is moved into a mail queue. Each mail queue has a different mail queue timeout value that specifies the maximum amount of time that a message may sit idle within a mail queue. The enterprise electronic mail system may automatically move a message from a mail queue into a mailbox of an enterprise electronic mail system user that subscribed to the mail queue. If the mail queue timer expires, then the message is routed to another mail queue or enterprise electronic mail user. The Shaw patent does not depict a method and system of customized electronic mail delivery verification or verification of an electronic mail recipient identity prior to receipt of the electronic message by the recipient from the originator.

The Nielson patent discloses a system for warning the originator of an electronic mail message if the message is not received. The Nielson system permits the originator of a message to designate whether the originator wishes to be warned in case the message is not opened by the recipient prior to a time and date specified by the originator. The originator's system maintains a database of such messages, and automatically monitors incoming messages and updates the database as responses are received from recipients of messages. If a response is not received from a recipient prior to the specified date, the system generates a warning message to the originator. The Nielson patent does not depict a method and system of customized electronic mail delivery verification or verification of an electronic mail recipient identity prior to receipt of the electronic message by the recipient from the originator.

The Weber patent discloses an electronic mail network, the electronic mail network further comprises a plurality of nodes or computer stations that permit an electronic mail message originator to control down stream routing of the message. The system enables the originator of a message to specify which addresses should automatically be set when a recipient of the message replies to or forwards the message. The Weber patent enables the originator of an electronic mail distribution to specify one or more recipients in a reply address field as the destination whenever the recipient replies to the note. By way of example, User A sends a note to User B and designates User C in the reply address field. In the note, User A asks User B to reply with an answer to User C. User B reads the note, then selects the reply function. The system then automatically fills in the reply destination address field of User C. The Weber patent does not depict a method and system of customized electronic mail delivery verification or verification of an electronic mail recipient identity prior to receipt of the electronic message by the recipient from the originator.

The Johnson patent discloses a method and system for the prioritization of the display order of received electronic mail items. In one embodiment, the invention associates a priority sorting attribute with a first electronic mail item, sorts an in-basket list of electronic mail items by any priority sorting attribute associated with any electronic mail item in the in-basket list, said in-basket list including a listing for the first electronic mail item, and displays at least a portion of the sorted in-basket list in the sorted order. The priority sorting attribute may be associated with the first electronic mail item by either the originator or the receiver of the first electronic mail item. A priority sorting attribute may be associated by the originator with some but not all of the intended recipients of the first electronic mail item and the priority sorting attribute will then be associated with the first electronic mail item only as it is sent to those recipients with whom the priority sorting attribute has been associated. The Johnson patent does not depict a method and system of customized electronic mail delivery verification or verification of an electronic mail recipient identity prior to receipt of the electronic message by the recipient from the originator.

The Prior Art establishes that the tracking of electronic mail in and of itself is not a novel idea; however, existing electronic mail solutions fail to offer customized electronic mail processing options or customized delivery options, as contemplated by the method and system of the present invention using digital rights management.

The method of the present invention comprises a method and system whereby the originator of an electronic message utilizes a digital rights management (DRM) system to control various aspects of electronic message processing and electronic message delivery options. Specifically, the originator of an electronic message may elect to govern at least one of the following attributes of an outgoing electronic message: electronic message duration (how long the electronic message will be displayed to the intended recipient), or electronic message printing authorization (whether the intended recipient has permission to print a hard copy of the electronic message or a portion thereof), or end-user verification requirement (whether the end-user needs to be identified prior to the electronic message being displayed), or verification(whether the end-user must verify a numeric code to verify that the end-user has opened the message). Additionally, the method of the present inventive device confirms the time and date that an electronic mail was delivered to the intended recipient and the time and date that an electronic mail was read by the intended recipient.

The main problem with conventional methods of electronic mail delivery systems is that none of the prior art has a method, system or process whereby the originator of an electronic message (hereinafter the “Client”) can utilize an independent, third-party service (hereinafter the “Processing Unit”) that allows the originator of the electronic message to govern attributes of the electronic message's processing and the electronic message's delivery using a system of digital rights management.

Another problem with conventional methods of electronic mail delivery systems is that none of the prior art has a method, system or process whereby the originator of an electronic message (hereinafter the “Client”) can utilize an independent, third-party service (hereinafter the “Processing Unit”) that allows the originator of the electronic message to govern attributes of the electronic message's processing and the electronic message's delivery by specifying how long an electronic message can be displayed to the intended recipient, using a system of digital rights management.

Another problem with conventional methods of electronic mail delivery systems is that none of the prior art has a method, system or process whereby the originator of an electronic message (hereinafter the “Client”) can utilize an independent, third-party service (hereinafter the “Processing Unit”) that allows the originator of the electronic message to govern attributes of the electronic message's processing and the electronic message's delivery by specifying how an electronic message may or may not be printed by the intended recipient, using a system of digital rights management.

Another problem with conventional methods of electronic mail delivery systems is that none of the prior art has a method, system or process whereby the originator of an electronic message (hereinafter the “Client”) can utilize an independent, third-party service (hereinafter the “Processing Unit”) that allows the originator of the electronic message to govern attributes of the electronic message's processing and the electronic message's delivery by specifying an end-user identification requirement of intended recipient, prior to the intended recipient being able to view the electronic message, using a system of digital rights management.

Another problem with conventional methods of electronic mail delivery systems is that none of the prior art has a method, system or process whereby the originator of an electronic message (hereinafter the “Client”) can utilize an independent, third-party service (hereinafter the “Processing Unit”) that allows the originator of the electronic message to govern attributes of the electronic message's processing and the electronic message's delivery by specifying verification in the form of a numeric code before an electronic message can be displayed to the intended recipient, using a system of digital rights management.

Another problem with conventional method of electronic mail delivery systems is that current methods, systems or processes do not automatically notify the originator of an electronic message when the electronic message was read (opened) by the intended recipient, but rather confirms when the electronic mail was received (i.e., the equivalent of an electronic “return receipt”). There exists an obvious need, from the standpoint of the electronic message originator, to ascertain the exact time and date an electronic message was opened or read: In today's internet based, e-commerce environment, numerous contractual arrangements are dependent on establishing the precise time and date of not only receipt of an electronic message, but also the time and date that the message was read or opened by the intended recipient.

Another problem with conventional method of electronic mail delivery systems is that none of the prior art discloses a method, system or process for tracking the time and date an electronic message was read or opened that is user friendly. Conventional methods of tracking the time and date of delivery are beyond the technical ability of many lay people. The traditional methods of tracking electronic messages are comprised of complicated, technically laden, messages or confirmations that are generated internally by the electronic mail server. Such messages or confirmations are often beyond the ability of a lay person to access or to understand, and as such there exists a need for an independent authority to confirm when the electronic message was sent.

Another problem with conventional methods of electronic mail delivery systems is there exists no process or method whereby the originator can send an electronic message to an independent processing unit to “hold” the electronic message pending verification of the intended recipient's identity by the processing unit. Upon confirmation, the electronic message is released to the recipient and the originator is notified.

While the devices of the prior art may be suitable for the particular purpose to which they address, they are not as suitable for a method, program and system whereby the originator of an electronic message (hereinafter the “Client”) can utilize an independent, third-party service (hereinafter the “Processing Unit”) that allows the originator of the electronic message to govern attributes of the electronic message's processing and the electronic message's delivery using a system of digital rights management. The present inventive device is distinct from the prior art because it allows the originator of the electronic message to use digital rights management to govern at least one of the following: message duration, printing authorization, end-user authorization, and verification, with respect to the outgoing electronic message. Further, the digital rights management provides the originator of the electronic message with an independent confirmation that verifies the time and date that the electronic message was sent and the time and date that it was delivered and the associated digital rights management attributes.

In these respects, the certified electronic mail method and system according to the present invention, substantially departs from the conventional concepts and designs of the prior art, and in so doing provides an apparatus primarily developed for the purpose of a method, program and system to govern the processing and delivery of an electronic message using the digital rights management attributes.

### SUMMARY OF THE INVENTION

In view of the foregoing disadvantages inherent in the known types of method of electronic mail delivery now present in the prior art, the general purpose of the present invention, which will be described subsequently in greater detail, is to provide a new electronic mail system using digital rights management to control attributes of electronic message processing and electronic mail delivery and to provide the originator of the electronic message with verification of the time and date that the electronic message was opened or read and the digital rights management associated with the electronic message.

A primary purpose is to allow the originator of an electronic message the ability to govern the processing and delivery of the electronic message by selecting the duration by which the electronic message may be displayed to the intended recipient. Upon expiration of the message duration parameters, the electronic message is no longer available for viewing by the intended recipient.

A primary purpose is to allow the originator of an electronic message the ability to govern the processing and delivery of the electronic message by selecting the printing authorization that may be utilized by the intended recipient. The originator may elect to allow the intended recipient to print portions of the electronic message, or deny printing of any of the electronic message.

A primary purpose is to allow the originator of an electronic message the ability to govern the processing and delivery of the electronic message by selecting the end-user verification of the intended recipient prior to the electronic message being displayed. Upon verification of the end-user by the processing unit, the electronic message is made available for viewing to the intended recipient.

A primary purpose is to allow the originator of an electronic message the ability to govern the processing and delivery of the electronic message by selecting verification of the intended recipient using a numeric code prior to the electronic message being displayed. Upon verification of the end-user using a numeric code, the electronic message is made available for viewing to the intended recipient.

To attain the above identified purposes, the present invention generally comprises a method, system and process for receiving and sending, and confirming and registering, electronic mail sent over the internet, computer networks, satellite or other systems that facilitate electronic messaging using digital rights management prior to delivery of the electronic message. The described method uses a central processing unit to facilitate the receipt and delivery and confirmation of electronic mail, and an infrastructure that facilitates the receipt and processing and delivery of electronic mail. In any instance, the Client interfaces with the Processing Unit by way of a local computer system and the internet to tender a request.

A request for certified mail using digital rights management entails the Client (originator of the electronic message) accessing the Processing Unit and selecting the appropriate electronic message attributes. The Client may elect to govern at least one of the following attributes of an outgoing electronic message: (i) electronic message duration (how long the electronic message will be displayed to the intended recipient), or (ii) electronic message printing authorization (whether the intended recipient has permission to print a hard copy of the electronic message or a portion thereof), or (iii) end-user verification requirement using a numeric code (whether the end-user needs to be identified prior to the electronic message being displayed), or (iv) end-user verification using personal identification (whether the end-user must provide personal identification to verify that the end-user may open the message). Additionally, the method of the present inventive device confirms the time and date that an electronic mail was delivered to the intended recipient and the time and date that an electronic mail was read by the intended recipient. Upon processing and delivery of the electronic message, the method of the present invention provides the originator of the electronic message a confirmation via the independent processing unit (i.e., not the equivalent of a “return receipt” that is generated from the originator's own electronic mail server). Said confirmation comprises the attributes selected and the time and date of delivery. Typically, said confirmation will be in the form of a digital certificate that is archived for future use.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, it is to be understood that the phraseology and terminology employed herein are for the purpose of the description and should not be regarded as limiting. Other objects and advantages of the present invention will become obvious to the reader and it is intended that these objects and advantages are within the scope of the present invention. Specifically, with reference to the term “electronic mail” or “electronic message”, the invention is not limited in any way as to the content contained therein. “Electronic mail” includes, but is not limited to, text, audio, visual, video, and digital attachments and any necessary components thereof.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart that depicts an overview of the method of the present inventive device using the Processing Unit.

FIG. 1A is a flowchart that depicts an overview of the method of the present inventive device using the Client's remote computer system.

FIG. 2 is a flowchart that depicts the Client selecting the digital rights management attribute of message duration using the Processing Unit.

FIG. 2A is a flowchart that depicts the Client selecting the digital rights management attribute of message duration using the Client's remote computer system.

FIG. 3 is a flowchart that depicts the Client selecting the digital rights management attribute of print authorization using the Processing Unit.

FIG. 3A is a flowchart that depicts the Client selecting the digital rights management attribute of print authorization using the Client's remote computer system.

FIG. 4 is a flowchart that depicts the Client selecting the digital rights management attribute of verifying the end user via a numeric code using the Processing Unit.

FIG. 4A is a flowchart that depicts the Client selecting the digital rights management attribute of verifying the end user via a numeric code using the Client's remote computer system.

FIG. 5 is a flowchart that depicts the Client selecting the digital rights management attribute of verifying the end user via personal identification using the Processing Unit.

FIG. 5A is a flowchart that depicts the Client selecting the digital rights management attribute of verifying the end user via personal identification using the Client's remote computer system.

### DESCRIPTION OF THE PREFERRED EMBODIMENT

The present inventive device discloses a system, method and process to facilitate four primary functions as follow below:

(i) Certified electronic mail wherein the originator of the electronic mail has the ability to govern the processing and delivery of the electronic message by selecting the duration by which the electronic message may be displayed to the intended recipient. Upon expiration of the message duration parameters, the electronic message is no longer available for viewing by the intended recipient. Verification of message duration is a function of the processing unit, or a function of a software download, either of which sends the electronic mail on behalf of the Client to the intended recipient with the selected attributes. Upon processing and delivery of the electronic message, the method of the present invention provides the originator of the electronic message a confirmation via the independent processing unit (i.e., not the equivalent of a “return receipt” that is generated from the originator's own electronic mail server). Said confirmation comprises the digital rights management attributes selected and the time and date of delivery. Typically, said confirmation will be in the form of a digital certificate that is archived for future use.

(ii) Certified electronic mail wherein the originator of the electronic mail has the ability to govern the processing and delivery of the electronic message by selecting the print authorization parameters by which the electronic message may be printed by the intended recipient. Verification of the printing authorization parameters is a function of the processing unit, or a function of a software download, either of which sends the electronic mail on behalf of the Client to the intended recipient with the selected attributes. Upon processing and delivery of the electronic message, the method of the present invention provides the originator of the electronic message a confirmation via the independent processing unit (i.e., not the equivalent of a “return receipt” that is generated from the originator's own electronic mail server). Said confirmation comprises the digital rights management attributes selected and the time and date of delivery. Typically, said confirmation will be in the form of a digital certificate that is archived for future use.

(iii) Certified electronic mail wherein the originator of the electronic mail has the ability to govern the processing and delivery of the electronic message by requesting that the intended recipient be authorized or verified by the input of a numeric code prior to the electronic message being delivered. Upon input of a code provided to the intended recipient, the electronic message is available for viewing by the intended recipient. Verification of the intended recipient's numeric code is a function of the processing unit, or a function of a software download, either of which sends the electronic mail on behalf of the Client to the intended recipient with the selected attributes. Upon processing and delivery of the electronic message, the method of the present invention provides the originator of the electronic message a confirmation via the independent processing unit (i.e., not the equivalent of a “return receipt” that is generated from the originator's own electronic mail server). Said confirmation comprises the digital rights management attributes selected and the time and date of delivery. Typically, said confirmation will be in the form of a digital certificate that is archived for future use.

(iv) Certified electronic mail wherein the originator of the electronic mail has the ability to govern the processing and delivery of the electronic message by requesting that the intended recipient be authorized or verified by the input of a personal identification prior to the electronic message being delivered. Upon input of personal identification provided by the intended recipient, the electronic message is available for viewing by the intended recipient. Verification of the intended recipient's personal information is a function of the processing unit, or a function of a software download, either of which sends the electronic mail on behalf of the Client to the intended recipient with the selected attributes. Upon processing and delivery of the electronic message, the method of the present invention provides the originator of the electronic message a confirmation via the independent processing unit (i.e., not the equivalent of a “return receipt” that is generated from the originator's own electronic mail server). Said confirmation comprises the digital rights management attributes selected and the time and date of delivery. Typically, said confirmation will be in the form of a digital certificate that is archived for future use.

To achieve the above-identified objectives, the present inventive device utilizes an independent central processing unit (hereinafter the “Processing Unit”) that provides verification of the aforementioned methods. Broadly speaking, the Processing Unit electronic mail server interacts with regional electronic mail servers and local electronic mail servers and with independent local computer networks. Verification requests are tendered through a local computer system to the processing unit via the local and regional electronic mail servers. The destination data (the intended recipient) for electronic mail communication is acquired from the information described in electronic mail data retrieved from the local electronic mail server of the customer computer system. When destination data subjected to communication is described in electronic mail data retrieved from the electronic mail server, the destination data is routed via the processing unit to the intended electronic mail recipient.

In any of the following embodiments of the present invention, the Processing Unit utilizes conventional hardware and software applications. In the preferred embodiment, the main server will be the host server that tracks incoming and outgoing electronic messages; that tracks customer accounts and identities; that archives all relevant information for future use and/or reference; and that disseminates the foregoing data to regional/local servers and clients as necessary. The main server is the central processing unit that serves to receive client account information and to facilitate requests for services and transactions described herein. Said electronic mail processing system is comprised of the following elements:

(i) an information storage system that will receive the client's account registration information;

(ii) an information storage system that will receive the client's request for certified and Certified mail services, and for identity verification services;

(iii) an outgoing mail information system that will track the time and date of when the client's electronic message was sent to the intended recipient;

(iv) an outgoing mail information system that will track the time and date of when the client's electronic message was delivered to the intended recipient;

(v) an information verification storage system that will track notifications sent to the client in the form of a digital certificate that certify the time and date of when the electronic message was sent to the intended recipient;

(vi) an identity verification storage system that will track the criteria used to establish identity and the time and date of notifications regarding the same; and

(vii) an archive information storage system that will track all verifications for future retrieval by the client if necessary.

The main server structurally serves to store all of the information generated by the invention and its related processes, systems, and methods. The main server functions to receive the electronic requests for service from the Client and disseminate the requests to the appending infrastructure (the “head office”) where the request will be processed and packaged to allow tracking of the electronic mail.

The regional server interfaces with the main server. The regional sever in turn receives the information from the main server and disseminate it to the local servers. The regional server receives the electronic mail package from the main server and forwards the electronic mail to the intended local server. The structure and function of the regional server is to interface with the main server and provide tracking information of the electronic mail.

The local servers will in turn disseminate the electronic mail and/or information to the intended recipient. The local server interfaces with the regional server. The local server receives the electronic mail package and forwards it to the intended recipient as identified by the client. The structure and the function of the local server is to interface with the regional server and to provide tracking information of the electronic mail.

The interconnections between the servers include any and all networks and or systems or applications that facilitate the sending and receipt of electronic mail, and any and all infrastructure necessary to facilitate the sending, receipt and confirmation of electronic mail. The various processing systems may also include multiple main frame computers, such as a main frame computer which may be preferably coupled to Local Area Network by means of communications link. Those skilled in the art will appreciate that the main frame computer may be located a great geographic distance from the LAN.

In the preferred embodiment, the Client accesses a website on the World-Wide-Web (“WWW”) that is a function of the Processing Unit. The website provides information regarding the services available and the means by which the Client shall be granted access to the present invention. The website provides information regarding the how to utilize the present invention and the means by which the Client's remote computer shall register and submit information to the Processing Unit. The internet and the website thus serve as a point of entrance to the inventive device and the means through which the Client may submit a request for Certified electronic mail governed by digital rights management attributes.

The Client must register with the Processing Unit to use the service of its choice. The Processing Unit assigns an identification number or code and a password that corresponds to the registration account for future use by the Client and for the tracking of service requests. Upon registration, the Client may submit a Certified electronic mail request. The Client selects the appropriate service by way of a pull down menu on the website with the available options: Certified mail governed by message duration, Certified mail governed by printing authorization, Certified mail governed by end-user authorization, or Certified mail governed by personal identity verification. The Client submits the message, and any attachments thereto, along with the following information: the Client's account information, the Client's name, the Client's electronic mail address, the recipient's name, the recipient's electronic mail address, the service or services selected, the date the electronic mail message is to be sent on behalf of the Client, and any special requests or instructions thereto.

The Processing Unit keeps an internal record of the account request and a copy of the electronic mail content (if requested). The Processing Unit submits the electronic message to the intended recipient, as identified by the Client in the registration account, and tracks the submission, and processing, and delivery cycle of the electronic message. The electronic message clearly indicates that the Client is the originator of the electronic mail; the Processing Unit is an independent authority who facilitates the Client's request. Upon delivery of the electronic message, the Processing Unit sends the Client a “Confirmation Record”, typically in the form of a digital certificate, of the time and date of the submission and of the delivery of the electronic message. In the event the electronic mail message was undeliverable, the Confirmation Record will indicate the attempted delivery time and date. The processing Unit archives the Digital Certificate and the corresponding account information for future use and retrieval.

Turning now descriptively to the drawings, in which similar reference characters denote similar elements throughout the several views, the attached figures illustrate a certified electronic mail system, which comprises a method, system and process for receiving, processing, and delivering electronic mail with digital rights management attributes. The method an system of certified mail using digital rights management may be facilitated over either a computer network, an intranet, the internet, via satellite, or other systems that facilitate electronic messaging. Turning descriptively to the drawings, the Client utilizes the invention in one of four manners, as disclosed above in points i, ii, iii, and iv. It should be noted that the Client may opt to utilize more than one digital rights management attribute simultaneously. For example, the Client may elect to govern a single electronic message with a message duration restriction combined with a printing authorization restriction. Alternatively, a Client may opt to govern a single electronic message with an end-user verification restriction, a message duration restriction, and a printing authorization restriction, et cetera.

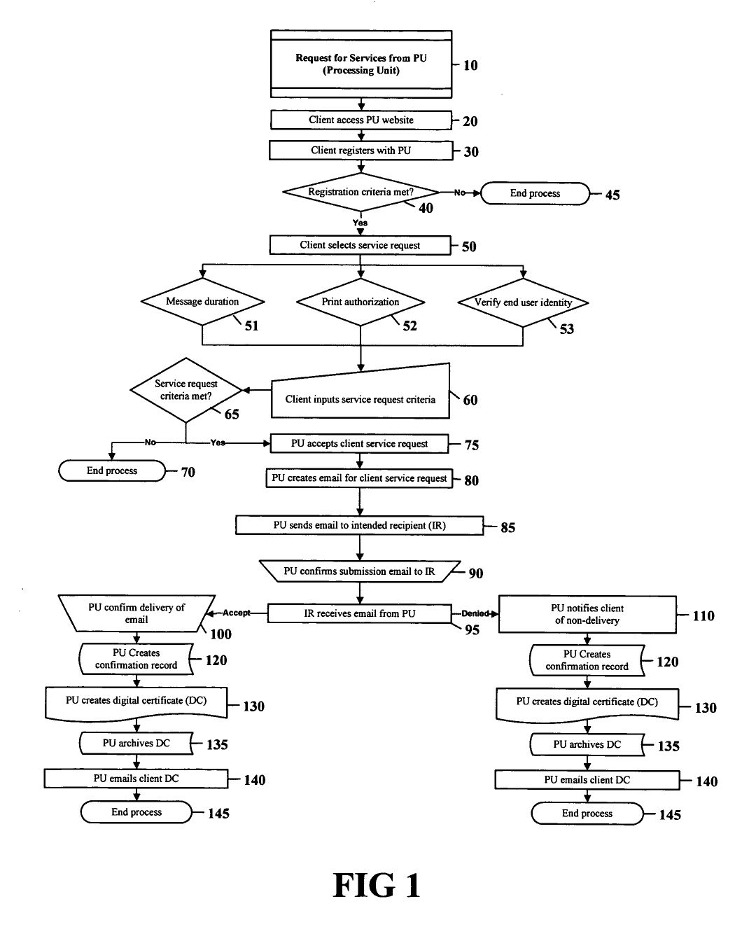

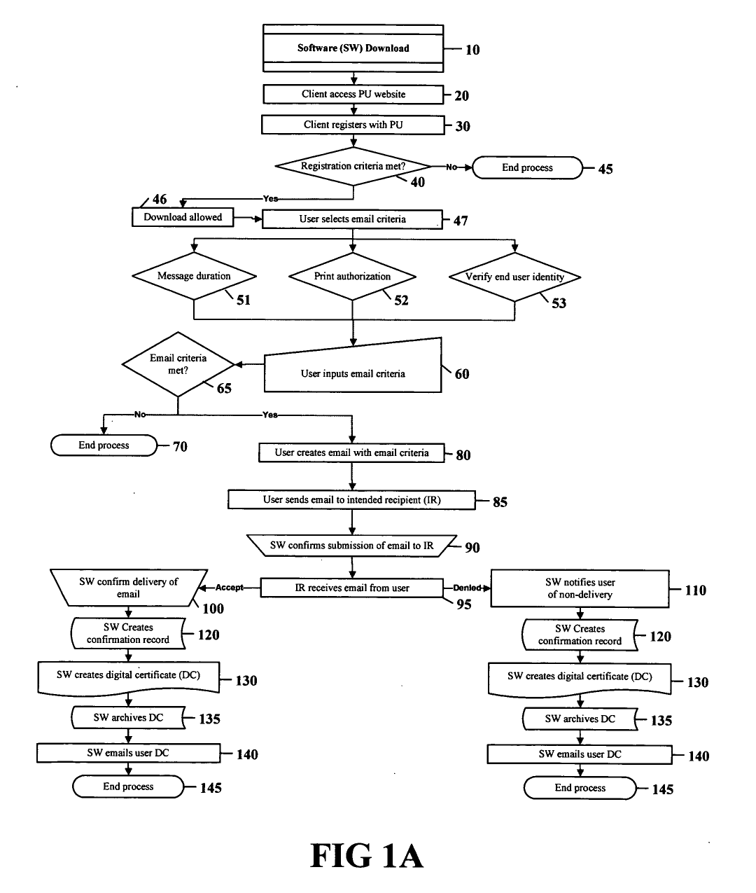

With reference to FIG. 1, the overall schematic of the present inventive device is depicted using the Processing Unit. The Processing Unit is an independent staffed entity that provides the services described herein on behalf of the Client. In the preferred embodiment, the Client accesses the services of the Processing unit via a website maintained by the Processing Unit. Alternatively, a Client may go to a physical location to utilize the services of the Processing Unit. To utilize any of the services offered by the present inventive device, the Client 10 must first access a website 20 and register 30 to utilize any of the digital rights management services described herein. If the registration criteria are successful 40, the Client is allowed access 50 to process a service request of either message duration 51, or print authorization 52, or verification of an end user identity 53. The Client selects the desired electronic message attributes 60 and submits to the Processing Unit 65 which in turn accepts the Client's service request 75 if the service request criteria are met 65. The Processing Unit creates the electronic message with the selected digital rights management attributes 80 and the Processing Unit submits/emails the electronic message to the intended recipient 85. The Processing Unit confirms submission (i.e. the time electronic message was sent) 90 and the time of delivery 95 to the intended recipient. If the intended recipient accepts delivery or opens the electronic message 100 the Processing Unit creates a confirmation record 120. Said confirmation record 120 is converted to a digital certificate 130 that contains the time and date of delivery and the associated digital rights management attributes associated with the electronic message. The Processing Unit archives 135 a copy of the digital certificate 120 and emails the Client the digital certificate 140. In the event, the intended recipient does not accept delivery or fails to receive the electronic message 100 the Processing Unit notifies the Client of non-delivery 110. In the event of non-delivery, the Processing Unit creates a confirmation record 120. Said confirmation record 120 is converted to a digital certificate 130 that contains the time and date of non-delivery and the associated digital rights management attributes associated with the electronic message. The Processing Unit archives 135 a copy of the digital certificate 120 and emails the Client the digital certificate 140.

With reference to FIG. 1A, the overall schematic of the present inventive device is depicted using a software download made available to the Client by way of the website. The software download is an application that allows the Client to utilize the digital rights management attributes independent of the Processing Unit. To utilize any of the services offered by the present inventive device's software, the Client 10 must first access a website 20 and register 30 to utilize any of the digital rights management services described-herein. If the registration criteria are successful 40, the Client is allowed to download the software 46. Upon a successful installation of the software, the Client selects 47 the attributes to govern the electronic message: either message duration 51, or print authorization 52, or verification of an end user identity 53. The Client selects the desired electronic message attributes 60 creates the electronic message with the selected digital rights management attributes 80. The Client submits/emails the electronic message to the intended recipient 85. The software confirms submission (i.e. the time electronic message was sent) 90 and the time of delivery 95 to the intended recipient. If the intended recipient accepts delivery or opens the electronic message 100 the software creates a confirmation record 120. Said confirmation record 120 is converted to a digital certificate 130 that contains the time and date of delivery and the associated digital rights management attributes associated with the electronic message. The software archives 135 a copy of the digital certificate 120 and emails the Client the digital certificate 140. In the event, the intended recipient does not accept delivery or fails to receive the electronic message 100 the software notifies the Client of non-delivery 110. In the event of non-delivery, the software creates a confirmation record 120. Said confirmation record 120 is converted to a digital certificate 130 that contains the time and date of non-delivery and the associated digital rights management attributes associated with the electronic message. The software archives 135 a copy of the digital certificate 120 and emails the Client the digital certificate 140.

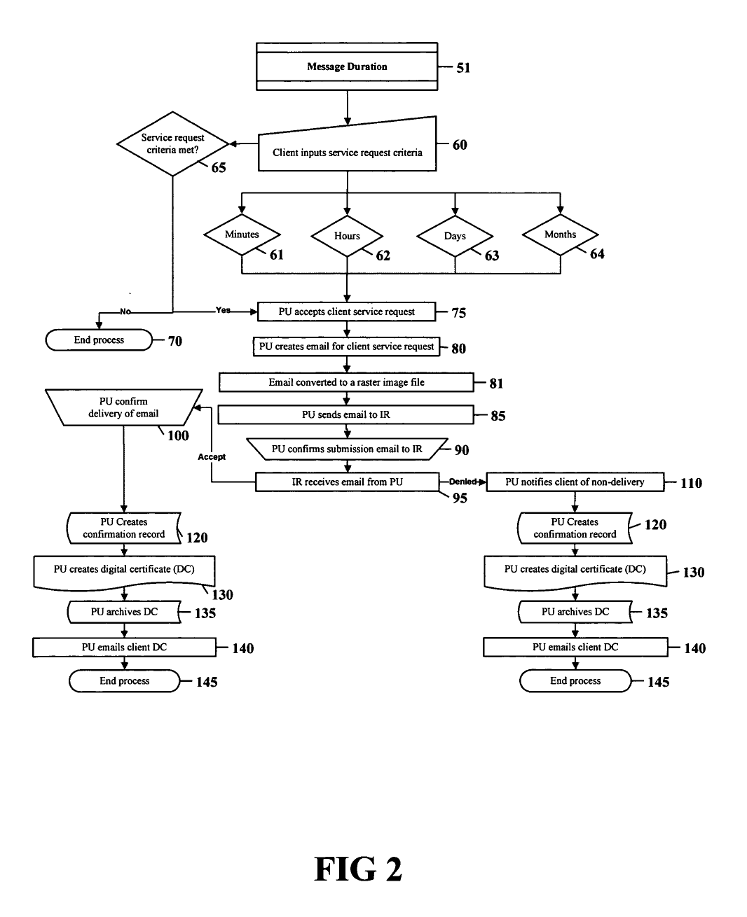

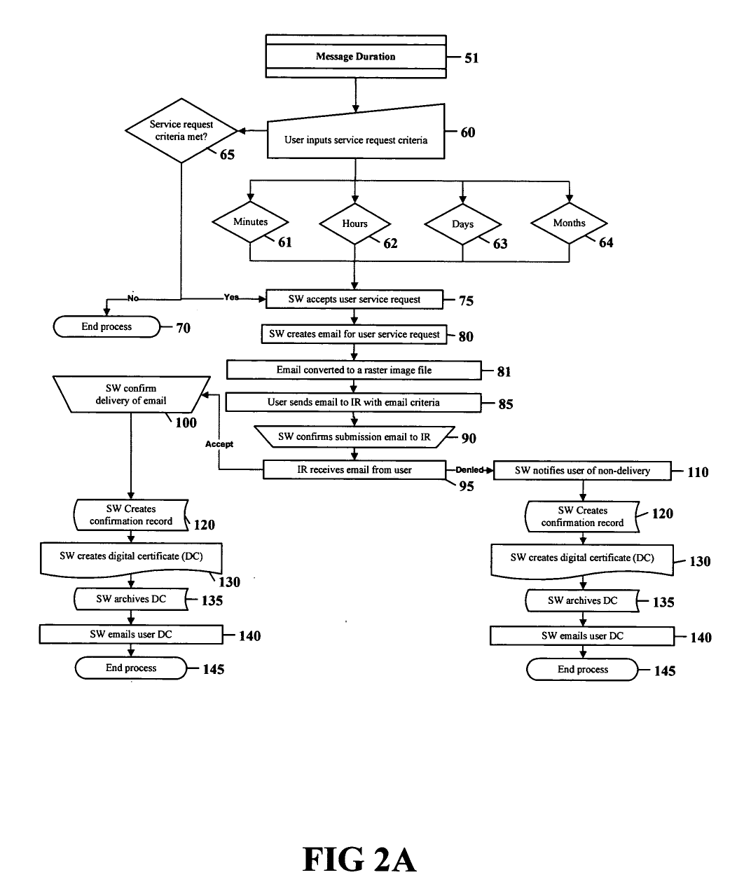

With reference to FIG. 2, the digital rights management attribute of message duration is depicted using the Processing Unit. The Client selects message duration 51 as the desired electronic message attribute 60, and the parameters of the time the electronic message is to be displayed in increments of at least one of the group of a minute 61, an hour 62, a day 63, or a month 64. The Client submits the service request 65 to the Processing Unit which in turn accepts the Client's service request 75 if the service request criteria are met 65. The Processing Unit creates the electronic message with the selected digital rights management attributes 80 by converting the electronic message to a raster image file 81. The Processing Unit submits/emails the electronic message to the intended recipient 85. The Processing Unit confirms submission (i.e. the time electronic message was sent) 90 and the time of delivery 95 to the intended recipient. If the intended recipient accepts delivery or opens the electronic message 100 the Processing Unit creates a confirmation record 120. Said confirmation record 120 is converted to a digital certificate 130 that contains the time and-date of delivery and the associated digital rights management attributes associated with the electronic message. The Processing Unit archives 135 a copy of the digital certificate 120 and emails the Client the digital certificate 140. In the event, the intended recipient does not accept delivery or fails to receive the electronic message 100 the Processing Unit notifies the Client of non-delivery 110. In the event of non-delivery, the Processing Unit creates a confirmation record 120. Said confirmation record 120 is converted to a digital certificate 130 that contains the time and date of non-delivery and the associated digital rights management attributes associated with the electronic message. The Processing Unit archives 135 a copy of the digital certificate 120 and emails the Client the digital certificate 140.

With reference to FIG. 2A, the digital rights management attribute of message duration is depicted using the software download. The Client selects message duration 51 as the desired electronic message attribute 60, and the parameters of the time the electronic message is to be displayed in increments of at least one of the group of a minute 61, an hour 62, a day 63, or a month 64. The Client submits the service request 65 using the software which in turn accepts the Client's service request 75 if the service request criteria are met 65. The software creates the electronic message with the selected digital rights management attributes 80 by converting the electronic message to a raster image file 81. The software submits/emails the electronic message to the intended recipient 85. The software confirms submission (i.e. the time electronic message was sent) 90 and the time of delivery 95 to the intended recipient. If the intended recipient accepts delivery or opens the electronic message 100 the software creates a confirmation record 120. Said confirmation record 120 is converted to a digital certificate 130 that contains the time and date of delivery and the associated digital rights management attributes associated with the electronic message. The software archives-135 a copy of the digital certificate 120 and emails the Client the digital certificate 140. In the event, the intended recipient does not accept delivery or fails to receive the electronic message 100 the software notifies the Client of non-delivery 110. In the event of non-delivery, the software creates a confirmation record 120. Said confirmation record 120 is converted to a digital certificate 130 that contains the time and date of non-delivery and the associated digital rights management attributes associated with the electronic message. The software archives 135 a copy of the digital certificate 120 and emails the Client the digital certificate 140.

With respect to FIG. 2 and FIG. 2A, the step of converting the electronic image to as raster image file allows the Processing unit or the software to control the length for which the electronic message, as a raster file image may be viewed.

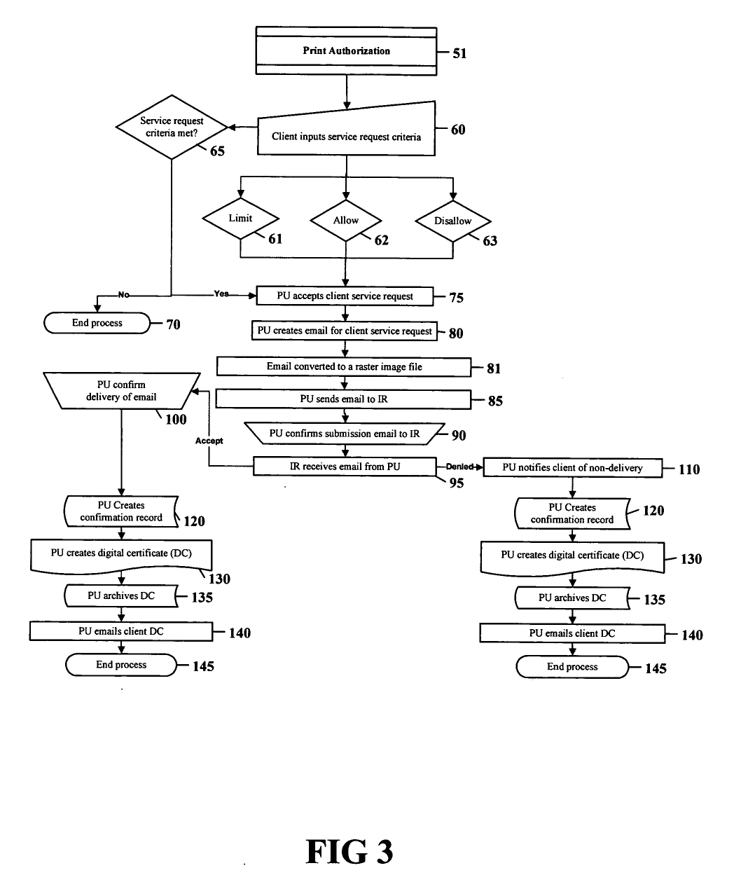

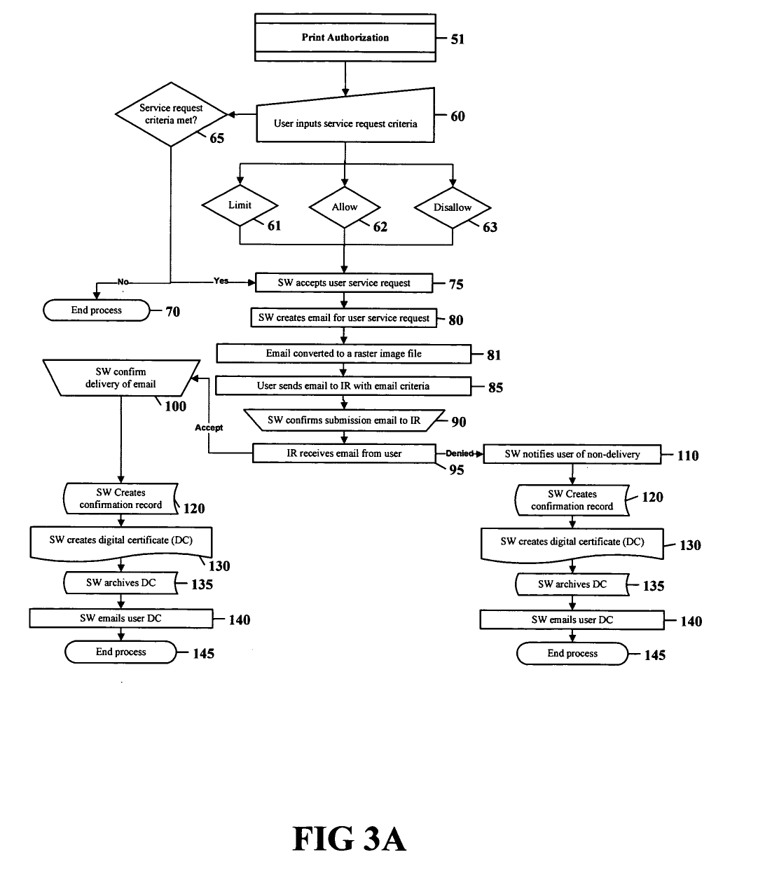

With respect to FIG. 3, the digital rights management attribute of print authorization is depicted using the Processing Unit. The Client selects print authorization 51 as the desired electronic message attribute 60, and the parameters of how the electronic message may be printed by selecting at least one of the group of: limit 61, allow 62, or disallow 63. The Client submits the service request 65 to the Processing Unit which in turn accepts the Client's service request 75 if the service request criteria are met 65. The Processing Unit creates the electronic message with the selected digital rights management attributes 80 by converting the electronic message to a raster image file 81. The Processing Unit submits/emails the electronic message to the intended recipient 85. The Processing Unit confirms submission (i.e. the time electronic message was sent) 90 and the time of delivery 95 to the intended recipient. If the intended recipient accepts delivery or opens the electronic message 100 the Processing Unit creates a confirmation record 120. Said confirmation record 120 is converted to a digital certificate 130 that contains the time and date of delivery and the associated digital rights management attributes associated with the electronic message. The Processing Unit archives 135 a copy of the digital certificate 120 and emails the Client the digital certificate 140. In the event, the intended recipient does not accept delivery or fails to receive the electronic message 100 the Processing Unit notifies the Client of non-delivery 110. In the event of non-delivery, the Processing Unit creates a confirmation record 120. Said confirmation record 120 is converted to a digital certificate 130 that contains the time and date of non-delivery and the associated digital rights management attributes associated with the electronic message. The Processing Unit archives 135 a copy of the digital certificate 120 and emails the Client the digital certificate 140.

With respect to FIG. 3A, the digital rights management attribute of print authorization is depicted using the software download. The Client selects print authorization 51 as the desired electronic message attribute 60, and the parameters of how the electronic message may be printed by selecting at least one of the group of: limit 61, allow 62, or disallow 63. The Client submits the service request 65 using the software which in turn accepts the Client's service request 75 if the service request criteria are met 65. The software creates the electronic message with the selected digital rights management attributes 80 by converting the electronic message to a raster image file 81. The software submits/emails the electronic message to the intended recipient 85. The software confirms submission (i.e. the time electronic message was sent) 90 and the time of delivery 95 to the intended recipient. If the intended recipient accepts delivery or opens the electronic message 100 the software creates a confirmation record 120. Said confirmation record 120 is converted to a digital certificate 130 that contains the time and date of delivery and the associated digital rights management attributes associated with the electronic message. The software archives 135 a copy of the digital certificate 120 and emails the Client the digital certificate 140. In the event, the intended recipient does not accept delivery or fails to receive the electronic message 100 the software notifies the Client of non-delivery 110. In the event of non-delivery, the software creates a confirmation record 120. Said confirmation record 120 is converted to a digital certificate 130 that contains the time and date of non-delivery and the associated digital rights management attributes associated with the electronic message. The software archives 135 a copy of the digital certificate 120 and emails the Client the digital certificate 140.

With respect to FIG. 3 and FIG. 3A, the step of converting the electronic image to as raster image file allows the Processing unit or the software to control how the electronic message, as a raster file image may be printed. Portions of the electronic message as an image may be printable, or conversely, none of the electronic message, as a raster file image, may be printable.

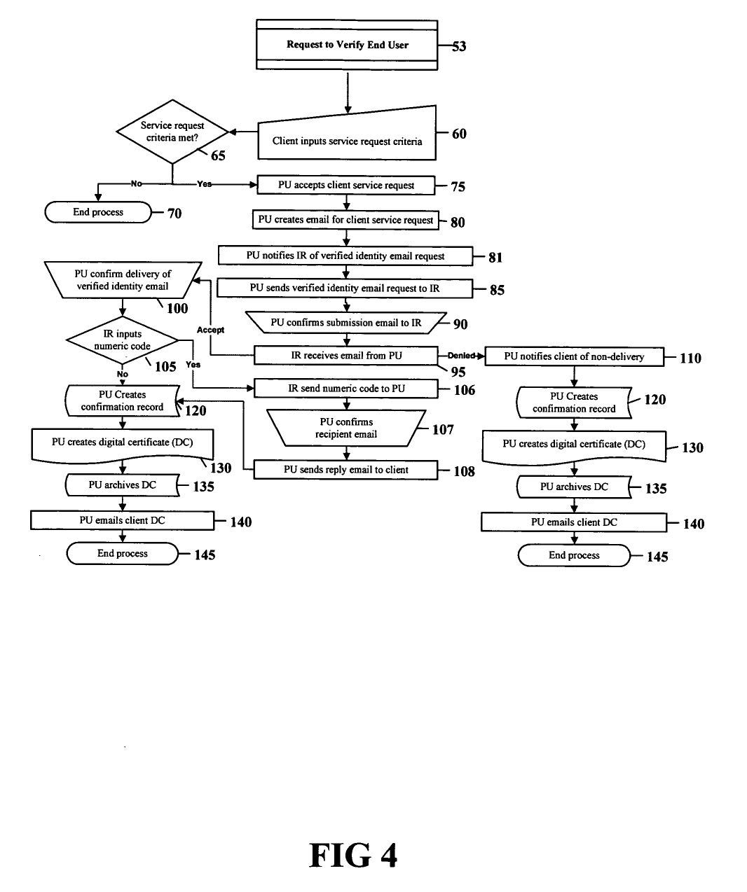

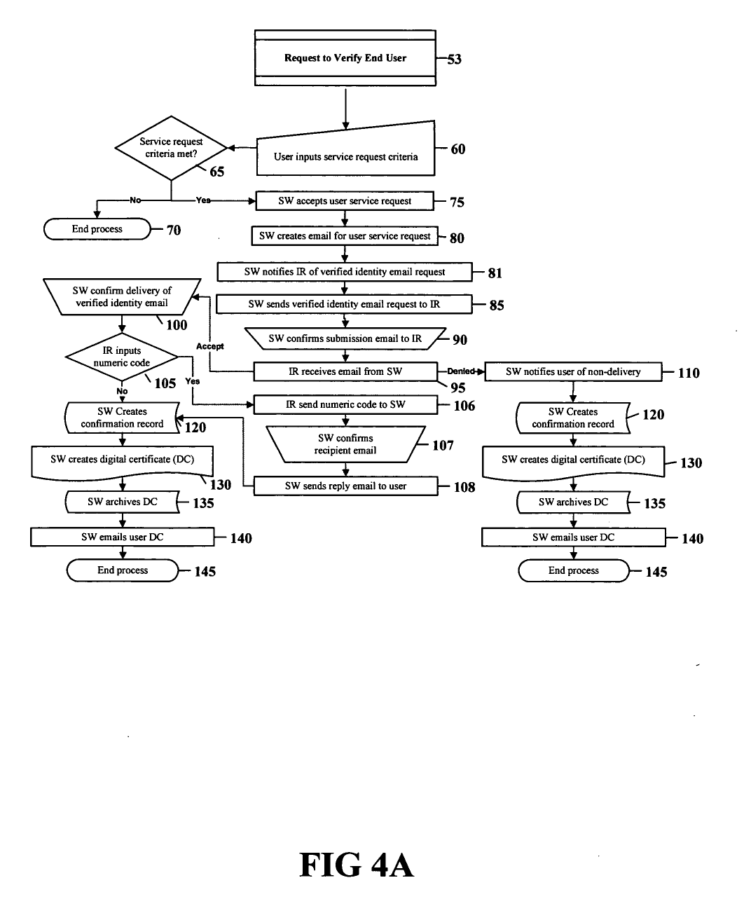

With respect to FIG. 4, the digital rights management attribute of verifying an end-user via a numeric code 53 is depicted using the Processing Unit. The Client selects a request to verify end user 53 as the desired electronic message attribute 60. The Client submits the service request 65 to the Processing Unit which in turn accepts the Client's-service request 75 if the service request criteria are met 65. The Processing Unit creates the electronic message with the selected digital rights management attributes 80. The Processing Unit notifies the intended recipient that the end user's identity must be verified prior to delivery of the electronic message 81. The Processing Unit submits/emails the verified identity request to the intended recipient 85. The Processing Unit confirms submission (i.e. the time electronic message was sent) 90 and the time of delivery 95 to the intended recipient. The Processing Unit confirms delivery of the verified identity service request 100. The intended recipient must input a numeric code to match one on file with the Processing Unit 105 and email/send the numeric code 53 to the Processing Unit 106. The Processing Unit confirms that the verified identity request was successful 107 (the end user code matches the one provided to the Processing Unit in the service request) and notifies the Client of a positive match 107. If the intended recipient accepts delivery or opens the electronic message 100 the Processing Unit creates a confirmation record 120. Said confirmation record 120 is converted to a digital certificate 130 that contains the time and date of delivery and the associated digital rights management attributes associated with the electronic message. The Processing Unit archives.135 a copy of the digital certificate 120 and emails the Client the digital certificate 140. In the event, the intended recipient does not accept delivery or fails to receive the electronic message 100 the Processing Unit notifies the Client of non-delivery 110. In the event of non-delivery, the Processing Unit creates a confirmation record 120. Said confirmation record 120 is converted to a digital certificate 130 that contains the time and date of non-delivery and the associated digital rights management attributes associated with the electronic message. The Processing Unit archives 135 a copy of the digital certificate 120 and emails the Client the digital certificate 140.

With respect to FIG. 4A, the digital rights management attribute of verifying an end-user via a numeric code 53 is depicted using the software download. The Client selects a request to verify end user 53 as the desired electronic message attribute 60. The Client submits the service request 65 using the software which in turn accepts the Client's service request 75 if the service request criteria are met 65. The software creates the electronic message with the selected digital rights management attributes 80. The software notifies the intended recipient that the end user's identity must be verified prior to delivery of the electronic message 81. The software submits/emails the verified identity request to the intended recipient 85. The software confirms submission (i.e. the time electronic message was sent) 90 and the time of delivery 95 to the intended recipient. The software confirms delivery of the verified identity service request 100. The intended recipient must input a numeric code to match one on file with the software 105 and email/send the numeric code 53 to the email identified by the software 106. The software confirms that the verified identity request was successful 107 (the end user code matches the one provided to the software in the service request) and notifies the Client of a positive match 107. If the intended recipient accepts delivery or opens the electronic message 100 the software creates a confirmation record 120. Said confirmation record 120 is converted to a digital certificate 130 that contains the time and date of delivery and the associated digital rights management attributes associated with the electronic message. The software archives 135 a copy of the digital certificate 120 and emails the Client the digital certificate 140. In the event, the intended recipient does not accept delivery or fails to receive the electronic message 100 the software notifies the Client of non-delivery 110. In the event of non-delivery, the software creates a confirmation record 120. Said confirmation record 120 is converted to a digital certificate 130 that contains the time and date of non-delivery and the associated digital rights management attributes associated with the electronic message. The software archives 135 a copy of the digital certificate 120 and emails the Client the digital certificate 140.

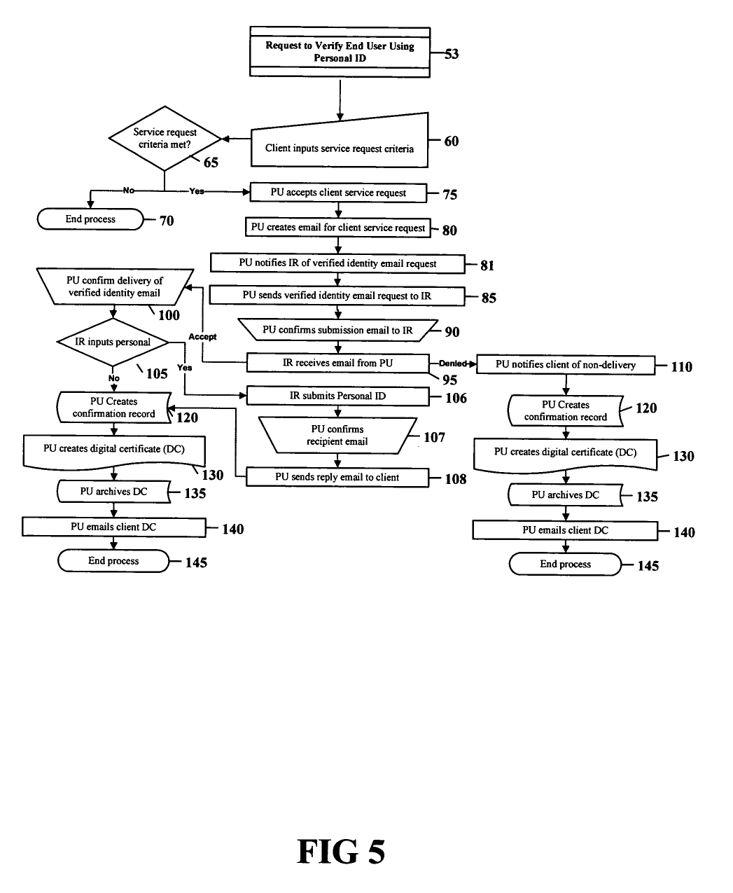

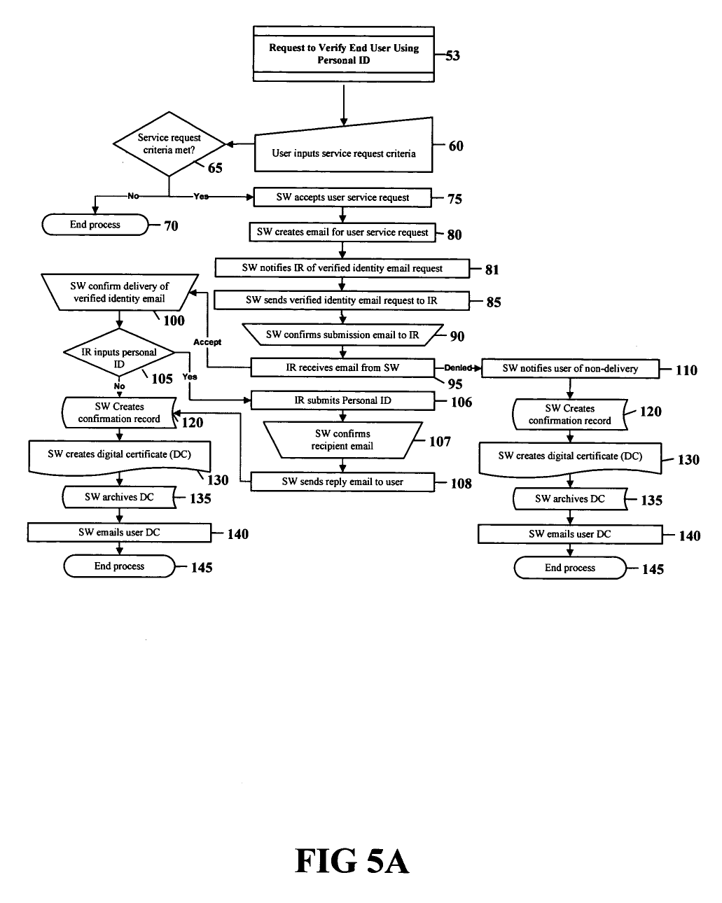

With respect to FIG. 5, the digital rights management attribute of verifying an end-user via a personal information 53 is depicted using the Processing Unit. The Client selects a request to verify end user 53 as the desired electronic message attribute 60. The Client submits the service request 65 to the Processing Unit which in turn accepts the Client's service request 75 if the service request criteria are met 65. The Processing Unit creates the electronic message with the selected digital rights management attributes 80. The Processing Unit notifies the intended recipient that the end user's identity must be verified prior to delivery of the electronic message 81. The Processing Unit submits/emails the verified identity request to the intended recipient 85. The Processing Unit confirms submission (i.e. the time electronic message was sent) 90 and the time of delivery 95 to the intended recipient. The Processing Unit confirms delivery of the verified identity service request 100. The intended recipient must input personal identification information to match the information requested on file with the Processing Unit 105 and email/send the personal identification information 53 to the Processing Unit 106. The Processing Unit confirms that the verified identity request was successful 107 (the personal identification information matches the information provided to the Processing Unit in the service request) and notifies the Client of a positive match 107. If the intended recipient accepts delivery or opens the electronic message 100 the Processing Unit creates a confirmation record 120. Said confirmation record 120 is converted to a digital certificate 130 that contains the time and date of delivery and the associated digital rights management attributes associated with the electronic message. The Processing Unit archives 135 a copy of the digital certificate 120 and emails the Client the digital certificate 140. In the event, the intended recipient does not accept delivery or fails to receive the electronic message 100 the Processing Unit notifies the Client of non-delivery 110. In the event of non-delivery, the Processing Unit creates a confirmation record 120. Said confirmation record 120 is converted to a digital certificate 130 that contains the time and date of non-delivery and the associated digital rights management attributes associated with the electronic message. The Processing Unit archives 135 a copy of the digital certificate 120 and emails the Client the digital certificate 140.

With respect to FIG. 5A, the digital rights management attribute of verifying an end-user via a personal information 53 is depicted using the software download. The Client selects a request to verify end user 53 as the desired electronic message attribute 60. The Client submits the service request 65 using the software which in turn accepts the Client's service request 75 if the service request criteria are met 65. The software creates the electronic message with the selected digital rights management attributes 80. The software notifies the intended recipient that the end user's identity must be verified prior to delivery of the electronic message 81. The software submits/emails the verified identity request to the intended recipient 85. The software confirms submission (i.e. the time electronic message was sent) 90 and the time of delivery 95 to the intended recipient. The software confirms delivery of the verified identity service request 100. The intended recipient must input personal identification information to match the information requested on file with the software 105 and email/send the personal identification information 53 to an email specified by the software 106. The software confirms that the verified identity request was successful 107 (the personal identification information matches the information provided to the Processing Unit in the service request) and notifies the Client of a positive match 107. If the intended recipient accepts delivery or opens the electronic message 100 the software creates a confirmation record 120. Said confirmation record 120 is converted to a digital certificate 130 that contains the time and date of delivery and the associated digital rights management attributes associated with the electronic message. The software archives 135 a copy of the digital certificate 120 and emails the Client the digital certificate 140. In the event, the intended recipient does not accept delivery or fails to receive the electronic message 100 the software notifies the Client of non-delivery 110. In the event of non-delivery, the software creates a confirmation record 120. Said confirmation record 120 is converted to a digital certificate 130 that contains the time and date of non-delivery and the associated digital rights management attributes associated with the electronic message. The software archives 135 a copy of the digital certificate 120 and emails the Client the digital certificate 140.

With respect to FIG. 5 an FIG. 5A, the recipient's identity may be verified by the following personal identification:

(i) having the intended recipient using a predetermined electronic code provided by the Client; or

(ii) having the intended recipient using a predetermined electronic code provided by the Processing Unit; or

(iii) having the intended recipient go to a Processing Unit service center for an in-person verification using the intended recipient's personal identification, including, at least one of the group of a birth certificate, a passport, a driver's license, government issue identity card, or a social security card; or

(iv) having the intended recipient provide bio-metric verification; or

(v) other means whereby the intended recipient utilizes a predetermined code, a password, or other means of encryption.

The function of the identity criteria is to verify the identity of an intended electronic mail recipient prior to receiving the electronic mail from the Client. The Processing Unit or the software “holds” processing and delivery of the electronic mail pending verification of the recipient's identity per the method or means specified by the Client in the corresponding account. The Processing Unit or the software notifies the intended recipient that the Processing Unit/Software is holding an electronic mail for the intended recipient pending verification of his/her identity. The Processing Unit or the software further provides the intended recipient with instructions on how to satisfy the Identity Verification request. The intended recipient may be prompted for a password or code, such as a digital certificate that may be submitted via electronic mail. Alternatively, the intended recipient may be required to provide an in-person verification using personal identity papers, or biometric information, at a stand-alone service center maintained by the present invention.

### DEFINITIONS

As the foregoing would illustrate, the inventive device is capable of a breadth of applications with respect to certified mail services using digital rights management. In this vein the following terms, as used herein, shall be construed to have the following meanings:

“Electronic Mail or Electronic Message or Email” are used interchangeably and all denote an electronic message with varied content contained therein. The electronic mail may comprise, but is not limited to, text data, audio data, visual data, video data, electronic data, electronic attachments and any necessary components thereof.

“Certified Electronic Mail” denotes a variety of services offered by the inventive device using a singular digital rights management attribute or a combination of attributes governed by digital rights management.

“Identity Verification” denotes a variety of services offered by the inventive device. The services may comprise, but are not limited to, verification using digital certificates, biometric information such as a thumbprint, voiceprint, retinal scan, a graphical, hand written signature, or personal identity papers such as a drivers license, a passport, and the like.

“Client” and “User” are used interchangeably and mean an individual or entity that tenders a request for services offered by the present invention.

“Intended Recipient” means an individual or entity as identified by the Client to receive the electronic message. A single electronic may have more than one intended recipient.

With respect to the above description then, it is deemed readily apparent and obvious to one skilled in the art, that all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method an system for sending an electronic message: governed by digital rights management attributes, said method and system further comprising a client, an intended recipient, a local computer system, a website, a processing unit, an email database, the means to certify said electronic message, the method and system comprising the steps of: said client using said local computer system to access said website and establish a registration account; said processing unit assigning a code to said registration account of said client; said client tendering a service request requesting that an email be governed by digital rights management; said processing unit receiving said service request; said service request being from said client; said processing unit storing information about said service request and said registration account in said email database; said processing unit processing said digital rights management attributes in accordance with said service request; said processing unit sending an electronic message with said digital rights management attributes associated with said electronic message to said intended recipient as identified by said client in said registration account; said processing unit tracking the date said electronic message was sent by said processing unit; said processing unit tracking the date said electronic message was received by said intended recipient; said processing unit creating a confirmation record that comprises said date said electronic message was sent and said date said electronic message was received by said intended recipient and said digital rights management attributes associated with said electronic message; said processing unit sending said client a copy of said confirmation record; and said processing unit storing said confirmation record and said registration account in said email database.

2. The method of claim 1 wherein said local computer system may be a remote fixed device or a remote portable device; whereby either said remote fixed device or said remote portable device access said website using the internet or other Transmission Control Protocol/Internet Protocol based network connectivity.

3. The system of claim 1 wherein said processing unit further comprises said email database; said email database further comprising an information storage system; said information storage system further comprising the means to store data; said data further comprising said registration account data, said electronic message data, said submission date data, said delivery date data, and said confirmation record data.

4. The method of claim 1 wherein said registration account data further comprises said client's name, said client's email address, said intended recipient's name, said intended recipient's email address, and the digital rights management services requested by said client.

5. The method of claim 1 whereby said digital rights management services comprise said processing unit sending said electronic message from said client to said intended recipient with at least one of the group the following attributes: a message duration restriction, or a printing authorization restriction, or an end-user identity verification requirement.

6. The method of claim 5 whereby said message duration restriction further comprises said client selecting parameters of at least one of the group of a minute, or an hour, or a day, or a month.

7. The method of claim 5 whereby said printing authorization restriction further comprises said client selecting parameters of at least one of the group of a limit, or to allow, or to disallow.

8. The method of claim 5 whereby said end-user verification requirement further comprises said client selecting parameters of at least one of the group of a numeric code, or biometric data, or a password, or personal identification information.

9. The method of claim 1 whereby said electronic message further comprises varied electronic data, including at least one of the group of text data, or audio data, or visual data, or video data, or electronic data, or electronic attachments.

10. The method of claim 1 whereby said website further comprises the means for said client to select said digital rights management attributes and to submit said electronic message in conjunction with said service request which details said digital rights management attributes selected, to said processing unit from said local computer system.

11. The method of claim 1 whereby said processing unit further comprises the means to receive said service request from said local computer system and to send said electronic message to said intended recipient in accordance with said digital rights management attributes selected by said client in said registration account.

12. The method of claim 1 whereby said processing unit further comprises the means to determine when said electronic message has been sent to said intended recipient and when said intended recipient has received said electronic message.

13. The method of claim 1 whereby said processing unit further comprises the means to notify said client of when said electronic message was sent to said intended recipient and when said electronic message was received by said intended recipient.

14. The system of claim 13 whereby said processing unit compiles the submission and delivery confirmation data into said confirmation record; said confirmation record further comprising said digital rights management attributes associated with said electronic message.

15. The method of claim 14 whereby said confirmation record is in the form of a digital certificate that is emailed to said client.

16. The method of claim 1 whereby said processing unit further comprises the means whereby a copy of said electronic message is archived and stored for future use and retrieval.

17. A method an system for sending an electronic message governed by digital rights management attributes, said method and system further comprising a client, an intended recipient, a local computer system, a website, a software download, an email database, the means to certify said electronic message, the method and system comprising the steps of: said client using said local computer system to access said website and establish a registration account; said processing unit assigning a code to said registration account of said client; said client downloading said software; said client tendering a service request requesting that an email be governed by digital rights management; said software receiving and processing said service request; said service request being from said client; said software storing information about said service request and said registration account in said email database; said software processing said digital rights management attributes in accordance with said service request; said software sending an electronic message with said digital rights management attributes associated with said electronic message to said intended recipient as identified by said client in said registration account; said software tracking the date said electronic message was sent; said software tracking the date said electronic message was received by said intended recipient; said software creating a confirmation record that comprises said date said electronic message was sent and said date said electronic message was received by said intended recipient and said digital rights management attributes associated with said electronic message; said software sending said client a copy of said confirmation record; and said software storing said confirmation record and said registration account in said email database.

18. The method of claim 17 wherein said local computer system may be a remote fixed device or a remote portable device; whereby either said remote fixed device or said remote portable device access said website using the internet or other Transmission Control Protocol/Internet Protocol based network connectivity.

19. The system of claim 17 wherein said software further comprises said email database; said email database further comprising an information storage system; said information storage system further comprising the means to store data; said data further comprising said registration account data, said electronic message data, said submission date data, said delivery date data, and said confirmation record data.

20. The method of claim 17 wherein said registration account data further comprises said client's name, said client's email address, said intended recipient's name, said intended recipient's email address, and the digital rights management services requested by said client.

21. The method of claim 17 whereby said digital rights management services comprise said processing unit sending said electronic message from said client to said intended recipient with at least one of the group the following attributes: a message duration restriction, or a printing authorization restriction, or an end-user identity verification requirement.

22. The method of claim 21 whereby said message duration restriction further comprises said client selecting parameters of at least one of the group of a minute, or an hour, or a day, or a month.

23. The method of claim 21 whereby said printing authorization restriction further comprises said client selecting parameters of at least one of the group of a limit, or to allow, or to disallow.

24. The method of claim 21 whereby said end-user verification requirement further comprises said client selecting parameters of at least one of the group of a numeric code, or biometric data, or a password, or personal identification information.

25. The method of claim 17 whereby said electronic message further comprises varied electronic data, including at least one of the group of text data, or audio data, or visual data, or video data, or electronic data, or electronic attachments.

26. The method of claim 17 whereby said software further comprises the means for said client to select said digital rights management attributes and to submit said electronic message with digital rights management attributes selected, to said intended recipient from said local computer system.

27. The method of claim 17 whereby said software further comprises the means to receive said service request from said local computer system and to send said electronic message to said intended recipient in accordance with said digital rights management attributes selected by said client in said registration account.

28. The method of claim 17 whereby said software further comprises the means to determine when said electronic message has been sent to said intended recipient and when said intended recipient has received said electronic message.

29. The method of claim 17 whereby said software further comprises the means to notify said client of when said electronic message was sent to said intended recipient and when said electronic message was received by said intended recipient.

30. The system of claim 29 whereby said software compiles the submission and delivery confirmation data into said confirmation record; said confirmation record further comprising said digital rights management attributes associated with said electronic message.

31. The method of claim 30 whereby said confirmation record is in the form of a digital certificate that is emailed to said client.

32. The method of claim 17 whereby said software further comprises the means whereby a copy of said electronic message is archived and stored for future use and retrieval.

33. The method of claim 1 wherein said digital rights management system further comprises the attribute of defining said message duration; said message duration further comprising how long said electronic message will be displayed or viewable to said intended recipient.

34. The method of claim 33 wherein said digital rights management system further comprises converting said electronic message into a raster image file.

35. The method of claim 17 wherein said digital rights management system further comprises the attribute of defining said message duration; said message duration further comprising how long said electronic message will be displayed or viewable to said intended recipient.

36. The method of claim 35 wherein said digital rights management system further comprises converting said electronic message into a raster image file.

37. The method of claim 1 wherein said digital rights management system further comprises the attribute of defining said printing authorization; said printing authorization further comprising what portions, if any, of said electronic message may be printed by said intended recipient.

38. The method of claim 37 wherein said digital rights management system further comprises converting said electronic message into a raster image file.

39. The method of claim 1 wherein said digital rights management system further comprises the attribute of verifying the end-user information of said recipient; said verifying end-user comprising said intended recipient inputting a numeric code and said processing unit verifying said numeric code.

40. The method of claim 17 wherein said digital rights management system further comprises the attribute of verifying the end-user information of said recipient; said verifying end-user comprising said intended recipient inputting a numeric code and said processing unit verifying said numeric code.

41. The method of claim 1 wherein said digital rights management system further comprises the attribute of verifying the end-user information of said recipient; said verifying end-user comprising said intended recipient inputting personal identification information and said processing unit verifying said personal identification information.

42. The method of claim 17 wherein said digital rights management system further comprises the attribute of verifying the end-user information of said recipient; said verifying end-user comprising said intended recipient inputting a numeric code and said processing unit verifying said numeric code.
